(19) United States
(12) Patent Application Publication
(10) Pub. No.: US 2008/0203002 A1
(43) Pub. Date: Aug. 28, 2008

(54) HIGH TREATMENT EFFICIENCY LEACH FIELD

(76) Inventor: David A. Potts, Killingworth, CT (US)

Correspondence Address: LAW OFFICE OF MICHAEL A. BLAKE, 112 BROAD STREET, MILFORD, CT, 06460, US

(21) Appl. No.: 12/042,757

(22) Filed: Mar. 5, 2008

Related U.S. Application Data
(63) Continuation-in-part of application No. 11/340,917, filed on Jan. 27, 2006, now Pat. No. 7,374,670.
Application No. 11/340,917 is a continuation-in-part of application No. 11/144,968, filed on Jun. 3, 2005.
(60) Provisional application No. 60/945,398, filed on Jun. 21, 2007.

(51) Int. Cl. C02F 1/00

(52) U.S. Cl. 210/170.08

(57) ABSTRACT

A leach field comprising: a channel, the channel comprising: an infiltrative volume, the infiltrative volume comprising: a plurality of opposing infiltrative surfaces, the surfaces being permeable; a volume of treatment media between each opposing pair of infiltrative surfaces; and a distance D between each opposing pair of infiltrative surfaces, where D is between about 2 inches and about 12 inches. A leach field system comprising: a channel, the channel comprising: an infiltrative volume, the infiltrative volume comprising: a plurality of opposing infiltrative surfaces; a bottom surface; a volume of treatment media between each opposing pair of infiltrative surfaces; a distance D between each opposing pair of infiltrative surfaces, and where the distance D is between about 2 inches and about 12 inches; a perforated pipe, with perforations located on the perforated pipe such that the perforations are lined up to and configured to allow fluid to flow from the perforations directly into the infiltrative volume; and where channel is configured to allow fluid to flow through the opposing infiltrative surfaces to the treatment media.

### CROSS-REFERENCES

This patent application claims the benefit of provisional patent application Ser. No. 60/945,398 by David A. Potts, entitled “High Treatment Efficiency Leach Field and Removable Form for Shaping a Leach Field”, filed on Jun. 21, 2007, the entire contents of which are fully incorporated by reference herein. This application is also a continuation in part of U.S. patent application Ser. No. 11/340,917, filed Jan. 27, 2006, entitled “High Aspect Ratio Wastewater System”, to David A. Potts, which is a continuation-in-part of U.S. patent application Ser. No. 11/144,968, filed on Jun. 3, 2005, entitled “Low Aspect Ratio Wastewater System”, by David A. Potts, the contents of both which are incorporated by reference herein in their entirety.

### BACKGROUND

The quality of water being discharged to the environment is an increasing concern. While septic system leach fields were primarily utilized to dispose of wastewater, there is increased concern as to how these devices are treating the wastewater in this process. An aim of this invention is to enhance the treatment of wastewater in as small a space as possible.

Historical beliefs have centered on the thought that wastewater was treated by the organic accumulations around the leach field system, often referred to as biomat. Our research has shown that this is in fact not accurate. We have found that soil, oxygen and the associated microbial communities are in fact responsible for the treatment. Based on this research, I have come up with specific embodiments that serve to enhance the treatment efficiencies of leach fields.

Prior art devices have focused on maximizing surface area in contact with the surrounding soil or fill. While this may be logical from a space perspective, it does not maximize treatment of the wastewater. The prior art devices often utilize similar theories to “pleated” filters. Examples of these prior art devices are shown in FIG. 1 and FIG. 2. These designs result in varying distances between the opposing surfaces. While this theory for increasing surface area may work for filtration, wastewater treatment requires reactions to occur and does not simply rely on the surface area of the filtration media. This variation results in varying treatment efficiencies, caused by wastewater traveling through differing amounts of soil. These differing amounts of soil result in varying levels of saturation and wastewater loading rate per unit volume of soil, consequently this results in varying oxygen to the microbial community. This oxygen supply is critical for treatment and for the life span of the system. In addition, the amount of soil that the wastewater contacts is also variable; this results in varying reactive surfaces on the soil/media particles.

The lifespan of leach fields, drain fields, etc. is directly related to the soil surface area that the wastewater can infiltrate through. Some products have been designed to maximize contact with soil surrounding the leach field lateral line. Products with infiltration chambers have sidewalls that utilize corrugations on the sidewalls to maximize surface area. Unfortunately, the chambers are typically made of impermeable plastic and have limited infiltration area between the slots and on the top; this limits infiltrative surface area. Other products have accordion shaped sidewalls, some of which are made with cardboard, while this is some what better than impermeable plastic—it still minimizes infiltrative capacity, assuming that the cardboard will fully degrade.

Thus there is a need for a leach field that promotes oxygenation for treatment of wastewater and overcomes the above listed and other disadvantages.

### SUMMARY

The disclosed invention relates to a leach field comprising: a channel, the channel comprising: an infiltrative volume, the infiltrative volume comprising: a plurality of opposing infiltrative surfaces, the surfaces being permeable; a volume of treatment media between each opposing pair of infiltrative surfaces; and a distance D between each opposing pair of infiltrative surfaces, where D is between about 2 inches and about 12 inches.

The disclosed invention also relates to a leach field system comprising: a channel, the channel comprising: an infiltrative volume, the infiltrative volume comprising: a plurality of opposing infiltrative surfaces; a bottom surface; a volume of treatment media between each opposing pair of infiltrative surfaces; a distance D between each opposing pair of infiltrative surfaces, and where the distance D is between about 2 inches and about 12 inches; a perforated pipe, with perforations located on the perforated pipe such that the perforations are lined up to and configured to allow fluid to flow from the perforations directly into the infiltrative volume; and where channel is configured to allow fluid to flow through the opposing infiltrative surfaces to the treatment media.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is a prior art filter;

FIG. 2 is a prior art filter;

FIG. 3 is a top view of a disclosed channel;

FIG. 4 is a top view of another embodiment of a disclosed channel;

FIG. 5 is a top view of discrete volume disclosed channel; and

FIG. 6 is a side view of the embodiment shown in FIG. 5.

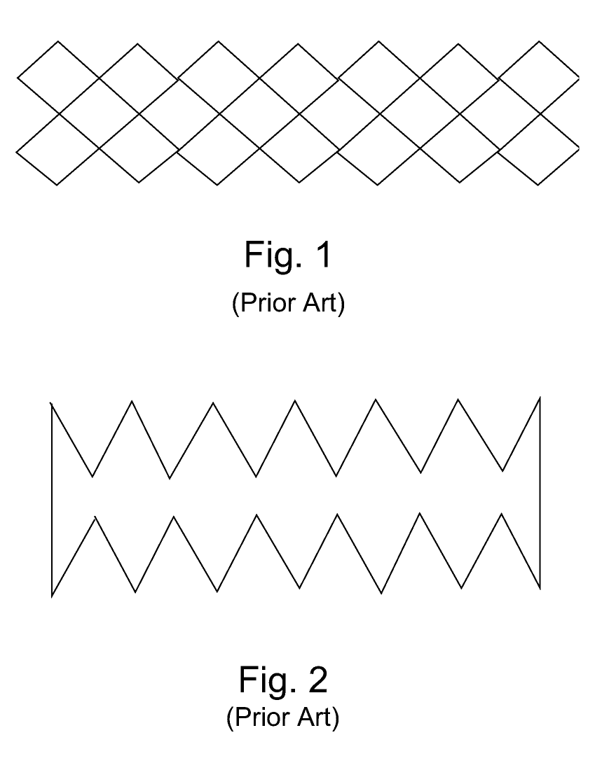

### DETAILED DESCRIPTION

### High Treatment Efficiency Leach Field

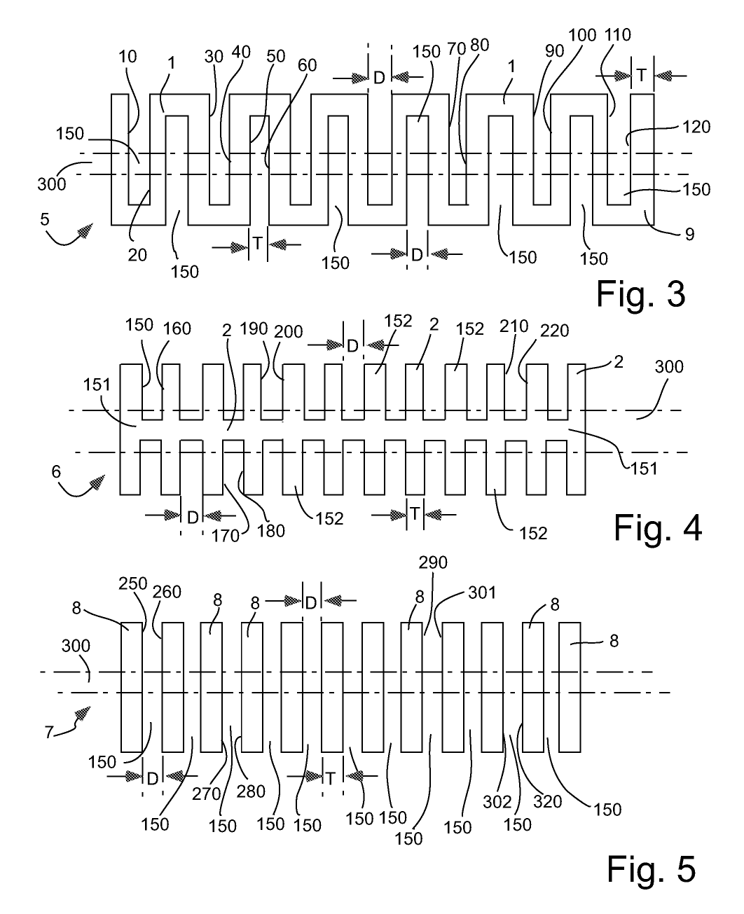

The inventor has discovered that leach fields designed with a constant amount of soil between the opposing infiltrative surfaces results in a high level of oxygen transfer and subsequently a higher level of treatment. The inventor has found that a minimum of two inches of soil between the opposing infiltrative surfaces is required to maximize treatment. In addition, the inventor has found that more than 12 inches of soil starts minimizing treatment efficiencies. Based on this, the most efficient leach field from both a size and treatment efficiency perspective is one with largely opposing, parallel surfaces. Leach fields embodying the invention are shown in FIGS. 3 through 6.

Referring to FIG. 3, a top view of a channel 5 is shown comprising an infiltrative volume 1. In this embodiment, the infiltrative volume has a “snake shape”. Due to the snake shape of the infiltrative volume 1, the infiltrative volume has a plurality of opposing infiltrative surfaces, some of which are identified as surfaces 10, 20, 30, 40, 50, 60, 70, 80, 90, 100, 110 and 120. These opposing infiltrative surfaces should ideally have a distance D between them of between about 2 inches and about 12 inches. Located in this distance D between two opposing infiltrative surfaces, is a volume 150 of treatment media, including but not limited to soil, and fill. Fill can include, but is not limited to: sand, locality approved septic fill, pearlite, and the equivalents, and other treatment media. These opposing infiltrative surfaces 10, 20, 30, 40, 50, 60, 70, 80, 90, 100, 110, 120 are generally parallel to each other. The height of the channel (that is the dimension that goes into the paper in this top view) may be from about 3 inches to about 60 inches. In other embodiments encompassed by this patent application, the height of the channel may be greater than 60 inches. The infiltrative volume may have a thickness T. The thickness T may be between about ½ inch to 6 inches. If the thickness T is too wide, then there is wasted space leading to less contact by the fluid in the channel with the infiltrative surfaces. Additionally, if the thickness T is too wide, the channel is less effective in displacing gas, less effective at exchanging gases (anaerobic gases) in the leaching system with air, and less effective at transferring water through infiltrative surface to the soil. The infiltrative volume may comprise stone aggregate, crushed stone, plastic pieces, granular media, permeable media, and or other man made materials. In addition the infiltrative volume 1 may comprise a “geonet”. Known geonets may be comprised of an irregularly coiled stringy structure contained between one or two layers of air-permeable sheeting 48, which layers may feel to the touch like thin felt, and which is commonly and generically called geotextile. Geonets may be obtained from various manufacturers, such as, but not limited to: Enkadrain drainage system product No. 9120 from Colbond Inc., P.O. Box 1057, Enka, N.C. 28728; and the several geonets named Grasspave2, Gravelpave2, Rainstore2, Slopetame2, Draincore2, Surefoot4, Rainstore3 from Invisible Structures, Inc., 1600 Jackson Street, Suite 310, Golden, Colo. 80401, and Advanedge® flat pipe from Advanced Drainage Systems, Inc. 4640 Trueman Boulevard, Hilliard, Ohio 43026.

FIG. 4 shows another embodiment of the channel 6. Similarly to the channel 5 in FIG. 3, channel 6 comprises an infiltrative volume 2. Infiltrative volume 2 has a plurality of opposing infiltrative surfaces, some of which are identified as 150, 160, 170, 180, 190, 200, 210, 220. Infiltrative volume 2 has a central volume 151 that runs the length of the infiltrative volume 2. The central volume 151 has a width W. The infiltrative volume 2 has fingers 152 that are generally perpendicular to the central volume 151. Fingers 152 have a width T. W may be equal to T, or less than T, or greater than T. Similar to the embodiment described in FIG. 4, the infiltrative volume 2 may comprise stone aggregate, crushed stone, plastic pieces, granular media, permeable media, and or other man made materials. In addition the infiltrative volume 2 may comprise a “geonet”. Known geonets may be comprised of an irregularly coiled stringy structure contained between one or two layers of air-permeable sheeting 48, which layers may feel to the touch like thin felt, and which is commonly and generically called geotextile. Geonets may be obtained from various manufacturers, such as, but not limited to: Enkadrain drainage system product No. 9120 from Colbond Inc., P.O. Box 1057, Enka, N.C. 28728; and the several geonets named Grasspave2, Gravelpave2, Rainstore2, Slopetame2, Draincore2, Surefoot4, Rainstore3 from Invisible Structures, Inc., 1600 Jackson Street, Suite 310, Golden, Colo. 80401, and Advanedge® flat pipe from Advanced Drainage Systems, Inc. 4640 Trueman Boulevard, Hilliard, Ohio 43026.

With respect to the embodiments disclosed with respect to FIGS. 3 and 4, opposing infiltrative surfaces means two surfaces, wherein a first surface adjoins the infiltrative volume (1 or 2), a second surface adjoins the infiltrative volume (1 or 2), and in between the first and second opposing infiltrative surfaces is a volume of treatment media, such as soil or fill. Thus, the first and second opposing infiltrative surfaces oppose each other.

FIG. 5, shows another embodiment of the disclosed invention. In this embodiment, the leach field comprises a channel 7, that is made of discrete volumes 8. The discrete volumes 8 form a plurality of opposing infiltrative surfaces, some of which are identified as 250, 260, 270, 280, 290, 301, 310, 320. The discrete volumes 8, that make up the channel 7, may each have a thickness T. The thickness T may be between about ½ inch to about 12 inches thick. This thickness T may be referred to as the channel thickness. These opposing infiltrative surfaces should ideally have a distance D between them of between 2 and 12 inches of soil, fill or other treatment media between them in the volume specified as 150. With respect to the embodiments disclosed with respect to FIG. 5, opposing infiltrative surfaces means two surfaces, wherein a first surface adjoins a first discrete volume 8, a second surface adjoins a second discrete volume, and in between the first and second surfaces is a volume 150 of treatment media, such as soil or fill. Similar to the embodiment described in FIG. 4, the discrete volumes 8 may comprise stone aggregate, crushed stone, plastic pieces, granular media, permeable media, and or other man made materials. In addition the discrete volumes 8 may comprise a “geonet”. Known geonets may be comprised of an irregularly coiled stringy structure contained between one or two layers of air-permeable sheeting 48 or a cuspated plastic, which layers may feel to the touch like thin felt, and which is commonly and generically called geotextile. Geonets may be obtained from various manufacturers, such as, but not limited to: Enkadrain drainage system product No. 9120 from Colbond Inc., P.O. Box 1057, Enka, N.C. 28728; and the several geonets named Grasspave2, Gravelpave2, Rainstore2, Slopetame2, Draincore2, Surefoot4, Rainstore3 from Invisible Structures, Inc., 1600 Jackson Street, Suite 310, Golden, Colo. 80401, Advanedge® flat pipe from Advanced Drainage Systems, Inc. 4640 Trueman Boulevard, Hilliard, Ohio 43026; Cuspated plastic core product from Eljen Corporation, 125 Mckee St., East Hartford, Conn. 06108. Each of the discrete volumes 8 may also be referred to as a finger.

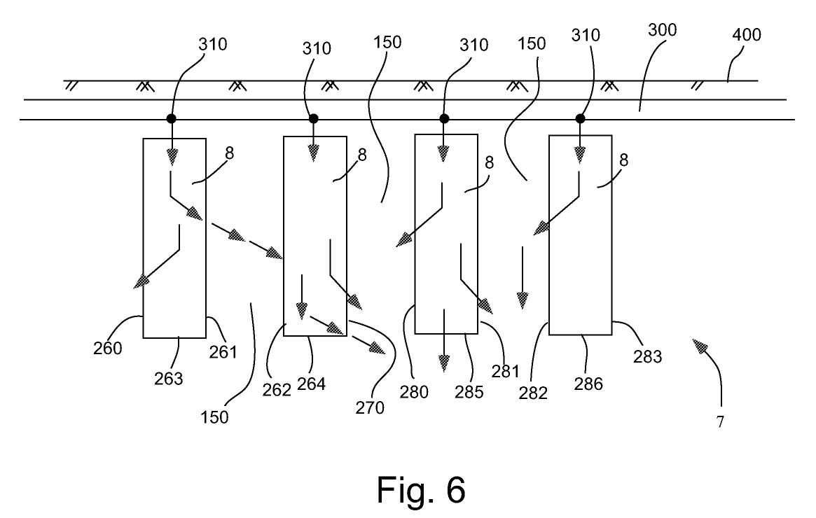

The infiltrative surfaces disclosed in this patent application may be interconnected (as shown in FIGS. 3 and 4) or fed with wastewater independently of one another (as shown in FIGS. 5 and 6). Wastewater can be supplied to the channels via a perforated pipe 300 that lies above or within the infiltrative volume and is shown in dashed lines. When a perforated pipe 300 is placed on top of the channel, aggregate material such as, but not limited to soil stone aggregate, crushed stone, plastic pieces, granular media, permeable media, geonet and or other man made materials; may be placed on top of the pipe and the channel. The channel 5, 6 may have a thickness T. Similarly, the discrete volume 8 may have a thickness T. The thickness T may be between about ½ inch to about 12 inches thick.

FIG. 6 shows a side view of the leach field shown in FIG. 5. In this view the ground surface 400 is shown. The perforated pipe 300 is shown with perforations 310 generally lined up with the discrete volumes 8 that make up the channel 7. The discrete volumes 8 have a plurality of opposing infiltrative surfaces identified as 260, 261, 262, 270, 280, 281, 282 and 283. Each volume 8 has a bottom surface, 263, 264, 285, and 286. Fluid is shown traveling from the perforated pipe 300 via the arrows. With respect to the volume 8 on the left side of the page, fluid is shown entering the volume from the perforation 310, and exiting the volume 8 via the surfaces 260 and 261. Additionally, fluid exiting surface 261 is shown entering the adjacent volume 8 through surface 262, and then leaving the volume 8 through surface 270. With respect to the volume 2^{nd} from the right (the volume 8 with surfaces 280, 281) fluid is shown entering the volume from the perforation 310, and exiting through both surfaces 280, 281 and also exiting the volume through the bottom surface 285 of the volume. Thus, it can be seen that fluid can pass from volume 8 through either opposing infiltrative surfaces 260, 261, 262, 270, 280, 281, 282 and 283, or through any of the bottom surfaces 263, 264, 285, and 286 of the volumes 8 that make up the channel 7, the bottom surfaces are prone to clogging, thus the side infiltrative surfaces are the primary infiltrative surfaces. Therefore it should be noted, that with respect to the channels 5 and 6, fluid can exit the channels through any of the opposing infiltrative surfaces as well as the bottom surface of the channels. In addition, fluid can enter the channels through the opposing infiltrative surfaces as well.

In this patent application, the “channel” refers to the infiltrative surfaces and the volume(s) 150 of treatment media. A fluid distribution pipe, such as the disclosed perforated pipe 300 is in fluid communication with the channel, but not part of the channel.

The disclosed invention has many advantages. The fact that the opposing infiltrative surfaces are generally parallel to each other and relatively close to each other lead to greater oxygenation in the leach field due in part to the fact that waste water exits the channel through these parallel surfaces, drawing air (air being a source of oxygen) behind the waste water. This “drawing of air” leads to greater oxygenation, which leads to better treatment of the waste water. The disclosed invention may also comprise a dosing device in fluid communication with the channel. The dosing device may be configured to fill about 25 to about 100% of the channel volume per dose, and allow the channel to largely drain before the next dose. Other advantages include the option of having the channel be in fluid communication with an air mover, a septic tank, and/or source of pretreated water.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims.

What is claimed is:

1. A leach field comprising:
a channel, the channel comprising:
an infiltrative volume, the infiltrative volume comprising:
a plurality of opposing infiltrative surfaces, the surfaces being permeable;
a volume of treatment media between each opposing pair of infiltrative surfaces; and
a distance D between each opposing pair of infiltrative surfaces, where D is between about 2 inches and about 12 inches.

2. The leach field of claim 1, wherein the channel has a thickness of about one half inch to about 12 inches.

3. The leach field of claim 1, wherein the channel has a thickness of about 1 inch to about 5 inches.

4. The leach field of claim 1, wherein the treatment media is selected from the group consisting of soil, sand, septic fill, crushed glass, and sand and gravel mixture.

5. The leach field of claim 1, wherein the infiltrative volume further comprises a media selected from the group consisting of stone aggregate, crushed stone, plastic pieces, granular media, permeable media, tire chips, ground rubber and geonet.

6. The leach field of claim 1, wherein the infiltrative volume is comprised of a plurality discrete volumes.

7. The leach field of claim 1, wherein the infiltrative volume is comprised of a single contiguous volume.

8. The leach field of claim 6, wherein the infiltrative volume has a snake shape.

9. The leach field of claim 6, wherein the infiltrative volume comprises:
a sub-channel that extends the length of the channel;
a plurality of fingers that orthogonally extend from the sub-channel; and
wherein for any pair of opposing infiltrative surfaces, the first opposing infiltrative surface will be on a first finger, and the second opposing infiltrative surface will be on a second finger that is adjacent to the first finger.

10. A leach field system comprising:
a channel, the channel comprising:
an infiltrative volume, the infiltrative volume comprising:
a plurality of opposing infiltrative surfaces;
a bottom surface;
a volume of treatment media between each opposing pair of infiltrative surfaces;
a distance D between each opposing pair of infiltrative surfaces, and where the distance D is between about 2 inches and about 12 inches;
a perforated pipe, with perforations located on the perforated pipe such that the perforations are lined up to and configured to allow fluid to flow from the perforations directly into the infiltrative volume; and
wherein channel is configured to allow fluid to flow through the opposing infiltrative surfaces to the treatment media.

11. The leach field of claim 10, wherein distance D is between about 2 inches and about six inches.

12. The leach field of claim 10, wherein the perforated pipe is located above the infiltrative volume.

13. The leach field of claim 10, wherein the perforated pipe is located within the infiltrative volume.

14. The leach field system of claim 10, wherein the channel is further configured to allow fluid to flow through the bottom surface.

15. The leach field system of claim 10, wherein the treatment media is selected from the group consisting of soil, sand, septic fill, crushed glass, and sand and gravel mixture.

16. The leach system field of claim 10, wherein the infiltrative volume further comprises a media selected from the group consisting of stone aggregate, crushed stone, plastic pieces, granular media, permeable media, tire chips, ground rubber and geonet.

17. The leach field system of claim 10, wherein the infiltrative volume is comprised of a plurality discrete volumes.

18. The leach field system of claim 10, wherein the infiltrative volume is comprised of a single contiguous volume.

19. The leach field system of claim 18, wherein the infiltrative volume has a snake shape.

20. The leach field system of claim 18, wherein the infiltrative volume comprises:
a sub-channel that extends the length of the channel;
a plurality of fingers that orthogonally extend from the sub-channel; and
wherein for any pair of opposing infiltrative surfaces, the first opposing infiltrative surface will be on a first finger, and the second opposing infiltrative surface will be on a second finger that is adjacent to the first finger.

21. The leach field system of claim 20, wherein the fingers each have a thickness of about one half inch to about 12 inches.

22. The leach field system of claim 10, further comprising a dosing device in fluid communication with the channel.

23. The leach field system of claim 22, where the dosing device is configured to provide a dose to the channel that is between about 50% and about 100% of the volume of the channel.

24. The leach field system of claim 10, further comprising an air mover in fluid communication with the channel.

25. The leach field of claim 10, further comprising a septic tank in fluid communication with the channel.

26. The leach field of claim 10, further comprising a source of pretreated water in communication with the channel.
